(19) United States
(12) Patent Application Publication
(10) Pub. No.: US 2025/0116946 A1
(43) Pub. Date: Apr. 10, 2025

(54) TONER

(71) Applicant: CANON KABUSHIKI KAISHA, Tokyo (JP)

(72) Inventors: KENTARO YAMAWAKI, Shizuoka (JP); KENJI AOKI, Shizuoka (JP); TATSUYA SAEKI, Shizuoka (JP); YUKI MASUDA, Shizuoka (JP)

(21) Appl. No.: 18/903,237

(22) Filed: Oct. 1, 2024

(30) Foreign Application Priority Data
Oct. 10, 2023 (JP) 2023-175090

(51) Int. Cl. G03G 9/087; G03G 9/097

(52) U.S. Cl. CPC G03G 9/08711; G03G 9/0874; G03G 9/08782; G03G 9/0975

(57) ABSTRACT

A toner having a toner particle including a binder resin and a release agent is provided, wherein the binder resin includes a crystalline resin and an amorphous resin, where in differential scanning calorimetry of the toner, a temperature is raised to obtain a differential scanning calorimetry curve A and then the temperature is lowered to obtain a differential scanning calorimetry curve B, the differential scanning calorimetry curve A has endothermic peaks derived from the crystalline resin and the release agent, the differential scanning calorimetry curve B has exothermic peaks derived from the crystalline resin and the release agent, and these endothermic peaks and exothermic peaks satisfy specific relationships, and a storage elastic modulus G′(TmB) of the toner at the endothermic peak temperature of the crystalline resin is 1.0×10⁵ Pa to 1.0×10⁸ Pa.

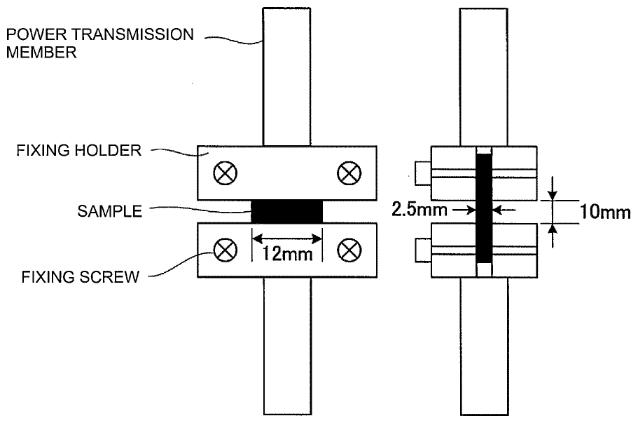

### BACKGROUND OF THE INVENTION

### Field of the Invention

The present disclosure relates to a toner for use in electrophotography and electrostatic recording.

### Description of the Related Art

Energy saving is considered to be a major technical issue in electrophotography devices as well, and a significant reduction in the energy required for fixing devices is being researched. For toners, techniques that improve the so-called “low-temperature fixability” that enables fixing with lower energy are being researched.

As a method for enabling fixing at low temperatures, a technique that uses a crystalline resin as a binder resin for toners is being researched. Crystalline resins have excellent heat-resistant storage stability because the molecular chains therein are regularly arranged, thereby very effectively preventing softening at temperatures lower than the melting point. Meanwhile, when the melting point is exceeded, the crystals melt suddenly, which is accompanied by a rapid drop in viscosity. For this reason, crystalline resins have attracted attention as materials that have excellent sharp melt property and low-temperature fixability.

Normally, crystalline vinyl resins have long-chain alkyl groups as side chains and show crystallinity because the long-chain alkyl groups on the side chains are oriented to each other. As a toner using a crystalline vinyl resin, Japanese Patent Application Publication No. 2020-173414 discloses a toner using a crystalline vinyl resin obtained by copolymerizing a polymerizable monomer having a long-chain alkyl group with an amorphous polymerizable monomer having an SP value different from that of the polymerizable monomer having a long-chain alkyl group.

Furthermore, Japanese Patent Application Publication No. 2018-151619 discloses a toner in which a polymerizable crosslinking agent is added or the amount thereof is increased and the amount of a gel component exhibiting high elasticity is increased in order to suppress the deterioration of hot offset resistance and of heat-resistant storage stability caused by the addition of a crystalline resin aimed at the improvement of low-temperature fixability.

### SUMMARY OF THE INVENTION

As mentioned above, when the melting point of a crystalline resin is exceeded, a sudden drop in viscosity occurs as the resin melts. This is an extremely excellent characteristic from the viewpoint of low-temperature fixability. Meanwhile, have a high crystallization rate, so when the crystalline resins are cooled from a molten state, the viscosity thereof rises rapidly. A problem resulting from a high crystallization rate is associated with color reproducibility, and this problem occurs because the viscosity rise starts before the colors are fully mixed. Another problem is associated with gloss uniformity of a fixed image that is affected by a difference in the volumetric shrinkage rate depending on the toner laid-on level.

The present disclosure is directed to a toner that has excellent low-temperature fixability and heat-resistant storage stability and also shows favorable color reproducibility and gloss uniformity of a fixed image.

The present disclosure relates to a toner comprising a toner particle comprising a binder resin and a release agent, wherein
the binder resin comprises a crystalline resin and an amorphous resin,
where in differential scanning calorimetry of the toner, a temperature is raised from 20° C. to 180° C. at a temperature rise rate of 10° C./min to obtain a differential scanning calorimetry curve A, then the temperature is held at 180° C. for 10 min, and subsequently the temperature is lowered from 180° C. to 10° C. at a temperature decrease rate of 10° C./min to obtain a differential scanning calorimetry curve B,
the differential scanning calorimetry curve A has an endothermic peak m(B) derived from the crystalline resin and an endothermic peak m(W) derived from the release agent,
the differential scanning calorimetry curve B has an exothermic peak c(B) derived from the crystalline resin and an exothermic peak c(W) derived from the release agent, and
where a peak temperature (° C.) of the endothermic peak m(B) is denoted by Tm(B), a peak temperature (° C.) of the endothermic peak m(W) is denoted by Tm(W), and
a peak temperature (° C.) of the exothermic peak c(B) is denoted by Tc(B), and a peak temperature (° C.) of the exothermic peak c(W) is denoted by Tc(W),
the Tm(B), the Tc(B), the Tm(W) and the Tc(W) satisfy

50.0≤Tm(B)≤80.0,

15.0≤Tm(B)−Tc(B)≤25.0,

Tc(W)≤Tm(B), and

15.0≤Tm(W)−Tc(W)≤25.0, and
a storage elastic modulus G′(TmB) of the toner at Tm(B) [° C.] is 1.0×10⁵ Pa to 1.0×10⁸ Pa.

The present disclosure can provide a toner that has excellent low-temperature fixability and heat-resistant storage stability and also shows favorable color reproducibility and gloss uniformity of a fixed image.

Further features of the present invention will become apparent from the following description of exemplary embodiments with reference to the attached drawing.

### BRIEF DESCRIPTION OF THE DRAWING

The FIGURE is an example of sample attachment for viscoelasticity measurement.

### DESCRIPTION OF THE EMBODIMENTS

In the present disclosure, unless otherwise specified, the descriptions “from XX to YY” and “XX to YY” that represent a numerical range mean a numerical range including the lower and upper limits that are the endpoints. When numerical ranges are described in stages, the upper and lower limits of each numerical range can be combined in any way.

(Meth)acrylic acid ester means acrylic acid ester and/or methacrylic acid ester.

In addition, in the present disclosure, a description such as “at least one selected from the group consisting of XX, YY, and ZZ” means any of XX, YY, ZZ, a combination of XX and YY, a combination of XX and ZZ, a combination of YY and ZZ, and a combination of XX, YY, and ZZ.

“Monomer unit” refers to the reacted form of a monomer substance in a polymer. For example, one section of carbon-carbon bond in the main chain of a polymer in which a vinyl monomer is polymerized is considered to be one unit. A vinyl monomer can be expressed by the following formula (6).

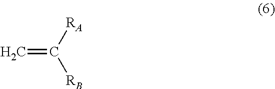

In formula (6), R_{A} represents a hydrogen atom or an alkyl group (preferably an alkyl group having 1 to 3 carbon atoms, more preferably a methyl group), and RB represents a freely selected substituent.

In addition, in the present disclosure, a crystalline resin refers to a resin that shows a clear endothermic peak in differential scanning calorimetry (DSC) measurement.

The present inventors conducted research to solve the above-mentioned problems. From the viewpoint of low-temperature fixability, it is necessary to speed up the decrease rate of melt viscosity of toner before fixing. Meanwhile, from the viewpoint of color mixing property and gloss uniformity, a certain decrease in the rise rate of melt viscosity is required for toner during fixing. Generally, crystalline resins have a high melting rate and also a high crystallization rate, and this property has been used to improve low-temperature fixability. Therefore, it is the nature of crystalline resins that the viscosity of toner during fixing increases quickly, and no attempt has been made to deliberately slow down the rise in melt viscosity.

To solve the above problems, the present inventors conducted in-depth research into whether it would be possible to appropriately control only the viscosity increase rate of toner during fixing without changing the viscosity decrease rate of toner before fixing. In the fixing process, it is possible to soften and mix a plurality of resin components in the toner by applying heat and pressure. Therefore, the inventors have considered that this can be utilized to control the crystallization rate of the toner during fixing, thereby solving the above-mentioned problems. An embodiment for achieving this is explained below.

The inventors have discovered that the following toner has excellent low-temperature fixability and heat-resistant storage stability, and also has excellent color reproducibility and image gloss uniformity.

The present disclosure relates to a toner comprising a toner particle comprising a binder resin and a release agent, wherein
the binder resin includes a crystalline resin and an amorphous resin,
where in differential scanning calorimetry of the toner, the temperature is raised from 20° C. to 180° C. at a temperature rise rate of 10° C./min to obtain a differential scanning calorimetry curve A, then the temperature is held at 180° C. for 10 min, and subsequently the temperature is lowered from 180° C. to 10° C. at a temperature decrease rate of 10° C./min to obtain a differential scanning calorimetry curve B,
the differential scanning calorimetry curve A has an endothermic peak m(B) derived from the crystalline resin and an endothermic peak m(W) derived from the release agent,
the differential scanning calorimetry curve B has an exothermic peak c(B) derived from the crystalline resin and an exothermic peak c(W) derived from the release agent, and
where the peak temperature (° C.) of the endothermic peak m(B) is denoted by Tm(B), the peak temperature (° C.) of the endothermic peak m(W) is denoted by Tm(W),
the peak temperature (° C.) of the exothermic peak c(B) is denoted by Tc(B), and the peak temperature (° C.) of the exothermic peak c(W) is denoted by Tc(W),
the Tm(B), the Tc(B), the Tm(W) and the Tc(W) satisfy

50.0≤Tm(B)≤80.0,

15.0≤Tm(B)−Tc(B)≤25.0,

Tc(W)≤Tm(B), and

15.0≤Tm(W)−Tc(W)≤25.0, and
a storage elastic modulus G′(TmB) of the toner at Tm(B)[C] is 1.0×10⁵ to 1.0×10⁸ Pa.

The toner of the present disclosure is described hereinbelow. The toner has a toner particle that includes a binder resin and a release agent. The binder resin includes a crystalline resin and an amorphous resin. By including a crystalline resin in the binder resin, it is possible to ensure heat-resistant storage stability of the toner while exhibiting low-temperature fixability. As described above, it is necessary that the toner have a high storage elastic modulus up to a temperature required for heat-resistant storage stability, and that the storage elastic modulus drop sharply when the temperature is higher than that, i.e., the toner is required to exhibit sharp melt property. As mentioned above, crystalline resins are an example of materials that exhibit sharp melt property.

Furthermore, in differential scanning calorimetry of the toner, the temperature is raised from 20° C. to 180° C. at a heating rate of 10° C./min to obtain differential scanning calorimetry curve A. The toner is then held at 180° C. for 10 min, and the temperature is then decreased from 180° C. to 10° C. at a temperature decrease rate of 10° C./min to obtain differential scanning calorimetry curve B. At this time, differential scanning calorimetry curve A has an endothermic peak m(B) derived from the crystalline resin and an endothermic peak m(W) derived from the release agent. Furthermore, differential scanning calorimetry curve B has an exothermic peak c(B) derived from the crystalline resin and an exothermic peak c(W) derived from the release agent.

Where the peak temperature (C) of endothermic peak m(B) is denoted by Tm(B), the peak temperature (° C.) of endothermic peak m(W) is denoted by Tm(W), the peak temperature (° C.) of exothermic peak c(B) is denoted by Tc(B), and the peak temperature (C) of exothermic peak c(W) is denoted by Tc(W), Tm(B), Tc(B), Tm(W) and Tc(W) satisfy the following formula.

$$\begin{matrix}50. \leq Tm ( B ) \leq 80. , \\ 15. \leq Tm ( B ) - Tc ( B ) \leq 25. , \\ Tc ( W ) \leq Tm ( B ) , and \\ 15. \leq Tm ( W ) - Tc ( W ) \leq 25. .\end{matrix}$$

Tm(B) represents the melting point of the crystalline resin. As a result of Tm(B) being 50.0° C. or higher, favorable heat-resistant storage stability can be obtained. Tm(B) is preferably 55.0° C. or higher, more preferably 58.0° C. or higher. As a result of Tm(B) being 80.0° C. or lower, favorable low-temperature fixability can be obtained. Tm(B) is preferably 75.0° C. or lower, more preferably 70.0° C. or lower. Tm(B) is preferably 55.0° C. to 75.0° C., more preferably 58.0° C. to 70.0° C. Tm(B) can be controlled by the type and molecular weight of the crystalline resin.

For example, the weight-average molecular weight of the crystalline resin is preferably 20000 to 40000, more preferably 25000 to 40000.

Tm(B)−Tc(B) is the difference between the temperature at which the crystalline resin is melted by heat and the temperature before the crystalline resin crystallizes when cooled again after melting, i.e., the crystallization rate. A small Tm(B)−Tc(B) represents a fast crystallization rate, and a large Tm(B)−Tc(B) represents a slow crystallization rate. This value is considered to be a measure of a thermal property corresponding to a rate at which the toner melts by receiving heat from the fixing member and the melt viscosity decreases during the fixing process of electrophotography, and then the toner cools after passing through the fixing unit and the melt viscosity increases.

A fast crystallization rate is one of the characteristics of crystalline resins, so it has been thought to be difficult to increase only the melting rate and, conversely, control the crystallization rate to be slow. In the toner of the present disclosure, Tm(B)−Tc(B) is 15.0° C. or more. Tm(B)−Tc(B) is preferably 17.0° C. or more. These ranges indicate that the crystallization rate is slower than that of the conventional crystalline resins.

The inventors have found that when Tm(B)−Tc(B) is in the above range, favorable color reproducibility can be obtained. It is believed that this is because the crystallization rate in the above range causes the melt viscosity to increase after the colors are thoroughly mixed during fixing in a multi-color laid-on image. The inventors have also found that when Tm(B)−Tc(B) is in the above range, the gloss uniformity of the fixed image can be improved. It is believed that this is because the crystallization rate in the above range reduces the difference in the volumetric shrinkage rate between areas with a high toner laid-on level and areas with a low toner laid-on level.

Furthermore, in the toner of the present disclosure, Tm(B)−Tc(B) is 25.0° C. or less. Tm(B)−Tc(B) is preferably 22.0° C. or less. The inventors have found that when Tm(B)−Tc(B) is in the above range, the gloss uniformity of the fixed image is improved. It is believed that this is because the crystallization rate is not too slow and is appropriate, making it possible to prevent the fixed image from being affected by the unevenness of the paper and becoming non-uniform in gloss. Tm(B)−Tc(B) is preferably 17.0° C. to 22.0° C., and more preferably 19.0° C. to 22.0° C.

Furthermore, Tc(B) is preferably 30.0° C. to 60.0° C., and more preferably 40.0° C. to 50.0° C.

Tm(B)−Tc(B) and Tm(W)−Tc(W) can be controlled within the above ranges by including an amorphous resin in addition to the crystalline resin at the same time and performing control by the structure, amount ratio, molecular chain length, etc. of the crystalline resin and the amorphous resin. It is believed that this is because when the toner melted during fixing crystallizes, the amorphous resin enters the molecular arrangement of the crystalline resin and controls the crystallization rate. More specifically, by bringing the structures and molecular chain lengths of the crystalline resin and the amorphous resin close to each other, and by setting the content of the amorphous resin to a preferred amount described hereinbelow, it is easier to control Tm(B)−Tc(B) within the above range. It is also believed that the above means for controlling Tm(B)−Tc(B) makes it easier to control Tm(W)−Tc(W) within the above range due to the interaction between the resin and the release agent.

From the viewpoint of low-temperature fixability, the content of the crystalline resin in the binder resin is preferably 25.0% by mass or more, and more preferably 35.0% by mass or more. The amount of the crystalline resin in the binder resin is preferably 25.0% by mass to 95.0% by mass, more preferably 35.0% by mass to 80.0% by mass, even more preferably 50.0% by mass to 75.0% by mass, and even more preferably from 65.0% by mass to 75.0% by mass.

Further, in order to control Tm(B)−Tc(B) and Tm(W)−Tc(W) within the above ranges, it is preferable that the crystalline resin contain a crystalline vinyl resin, and it is preferable that the amorphous resin contain an amorphous vinyl resin. It is more preferable that the crystalline resin be a crystalline vinyl resin, and it is more preferable that the amorphous resin be an amorphous vinyl resin. The crystalline vinyl resin has long-chain alkyl groups as side chains, and the long-chain alkyl groups in the side chains are oriented to each other, whereby crystallinity is exhibited. This allows the side chains of the crystalline vinyl resin and the amorphous vinyl resin to become more compatible and interact with each other, making it easier to control Tm(B)−Tc(B) within the above range. It is also believed that the above means for controlling Tm(B)−Tc(B) makes it easier to control Tm(W)−Tc(W) within the above range due to the interaction between the resin and the release agent.

From the viewpoint of controlling Tm(B)−Tc(B) and Tm(W)−Tc(W) within the above ranges, it is more preferable that the crystalline resin contain a monomer unit represented by the following formula (1) (more preferably formula (1-1)).

Further, it is more preferable that the crystalline resin contain a monomer unit having a lactam structure, and it is even more preferable that the crystalline resin contain a monomer unit having a five-membered lactam structure. It is still more preferable that the monomer unit having a lactam structure be represented by the following formula (L) (more preferably formula (L-1)). It is believed that when the crystalline resin has a lactam structure, the crystalline resin has polar sites, which facilitate interaction with other materials such as polyfunctional ester wax.

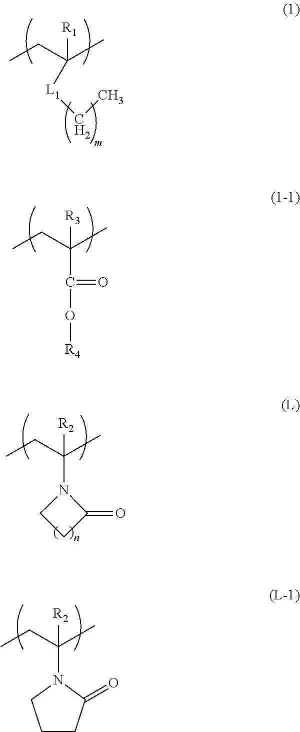

In formula (1), R₁ represents a hydrogen atom or a methyl group, L₁ represents a single bond, an ester bond, or an amide bond (preferably, an ester bond), and m represents an integer of 15 to 30 (preferably 17 to 29, more preferably 19 to 23).

In formula (1-1), R₃ represents a hydrogen atom or a methyl group, and R₄ represents a linear alkyl group having 16 to 31 carbon atoms (preferably 18 to 28, more preferably 20 to 24).

In formulas (L) and (L-1), R₂ represents a hydrogen atom or a methyl group. n is an integer of 1 to 4 (preferably 1 to 3).

Furthermore, the toner includes a release agent, and Tm(W)−Tc(W) represents the crystallization rate of the release agent. The inventors have found that in order to obtain the above effects, it is necessary to control not only the crystallization rate of the crystalline resin but also the crystallization rate of the release agent.

The inventors have found that favorable color reproducibility can be obtained by setting Tm(W)−Tc(W) to 15.0° C. or higher. This is thought to be because, as explained in relation to Tm(B)−Tc(B), in a multi-color laid-on image, the melt viscosity increases after the colors are thoroughly mixed during fixing. The inventors have also found that the gloss uniformity of the fixed image can be improved by setting Tm(W)−Tc(W) to 15.0° C. or higher. This is thought to be because, as explained in relation to Tm(B)−Tc(B), the difference in volumetric shrinkage rate between areas with a large laid-on level and areas with a small laid-on level can be reduced.

Furthermore, in the toner of the present disclosure, Tm(W)−Tc(W) is 25.0° C. or less. Tm(W)−Tc(W) is preferably 24.0° C. or less. The inventors have found that when Tm(W)−Tc(W) is in the above ranges, the gloss uniformity of the fixed image is improved. This is thought to be because, as in the above, it is possible to prevent the fixed image from being affected by the unevenness of the paper and becoming non-uniform in gloss. Tm(W)−Tc(W) is preferably 19.0° C. to 24.0° C., more preferably 20.0° C. to 24.0° C.

Tm(W) is preferably 60.0° C. to 85.0° C., more preferably 70.0° C. to 80.0° C.

Tc(W) is preferably 40.0° C. to 60.0° C., more preferably 47.0° C. to 57.0° C.

Tm(B)−Tc(B) and Tm(W)−Tc(W) can be controlled within the above ranges by the structure, mixing ratio, and molecular chain length of the crystalline resin and release agent. It is believed that this is because when the molten toner crystallizes, the crystalline resin and release agent form a eutectic, making it possible to control the crystallization rate.

As for the mixing ratio of the crystalline resin and release agent, the appropriate amounts thereof vary depending on the substances used, and the amounts can be freely selected. One method is to add the release agent in an amount that makes it easy to sufficiently control the crystallization rate. It is also preferable to use the release agent content described below so that the crystallization rate does not become too slow.

In addition, in order to control Tm(B)−Tc(B) and Tm(W)−Tc(W) within the above ranges, it is preferable that the release agent include a multifunctional ester wax. It is believed that the multifunctional ester wax not only causes a single crystalline resin molecule to form a eutectic, but also exists between the molecules in a bridging state, making it easier to apply the effect thereof to the entire resin.

The polyfunctional ester wax refers to an ester compound of a polyhydric alcohol and a monocarboxylic acid, and an ester compound of a polycarboxylic acid and a monohydric alcohol. The polyfunctional ester wax is preferably at least one ester compound selected from the group consisting of an ester compound of a tetrahydric to octahydric alcohol and an aliphatic monocarboxylic acid, and an ester compound of a tetravalent to octavalent carboxylic acid and an aliphatic monohydric alcohol. More preferably, the polyfunctional ester wax is at least one ester compound selected from the group consisting of an ester compound of a hexahydric to octahydric alcohol and an aliphatic monocarboxylic acid, and an ester compound of a hexavalent to octavalent carboxylic acid and an aliphatic monohydric alcohol.

Further, in order to control Tm(B)−Tc(B) within the above range, when a crystalline resin having a monomer unit of formula (1) is used, it is preferable to include at the same time a straight-chain fatty acid metal salt. The straight-chain fatty acid metal salt refers to a salt of a straight-chain fatty acid and a metal other than sodium or potassium. In particular, with regard to the relationship with m in formula (1), where the number of carbon atoms of the straight-chain fatty acid of the straight-chain fatty acid metal salt is denoted by C(b), it is preferable that C(b) satisfy m−10≤C(b)≤m+10, more preferably m−6≤C(b)≤m+6, and even more preferably m−4≤C(b)≤m+4. In addition, it is preferable that the valence of the metal in the straight-chain fatty acid metal salt be two or more. In other words, it is preferable that the straight-chain fatty acid metal salt be a salt of metal with a valence of two or more and a straight-chain fatty acid.

Where m−10≤C(b)≤m+10 is satisfied, it indicates that the chain length of the alkyl group in formula (1) is close to the chain length of the straight-chain fatty acid in the straight-chain fatty acid metal salt. In general, alkyl chains with similar chain lengths have a high affinity with each other. It is believed that by including a straight-chain fatty acid metal salt having a chain length close to the chain length of the alkyl group in formula (1) that exhibits crystallinity, it is possible to create a eutectic-like state of the crystalline resin and the straight-chain fatty acid metal salt. Therefore, it is possible to control the crystallization rate.

Furthermore, the fatty acid metal salts containing metals with a valence of two or more often have two or more alkyl chains, and are easily compatible with the alkyl chains of other crystalline resin molecules. It is believed that as a result, when the toner melts and the molecular chains become movable in the fixing process, the fatty acid metal salt introduced into the molecular chain of the crystalline resin is also introduced into other molecular chains of the crystalline resin, thereby creating a pseudo-bridged state and making it possible to exert an effect on the entire resin.

In the present disclosure, the valence of the metal in the straight-chain fatty acid metal salt being two or more means a metal type in which a single metal ion can take a valence of two or more. The divalent or higher metal is not particularly limited, and at least one selected from the group consisting of calcium and aluminum can be mentioned. Aluminum is preferable. The straight-chain fatty acid metal salt may be exemplified by at least one selected from the group consisting of zinc octylate, magnesium distearate, aluminum distearate, calcium distearate, zinc distearate, calcium montanate, calcium laurate, barium laurate, calcium ricinoleate, barium ricinoleate, zinc ricinoleate, etc. It is more preferable that the straight-chain fatty acid metal salt include aluminum distearate.

Furthermore, the toner satisfies Tc(W)≤Tm(B). By satisfying this, a toner with excellent color reproducibility and image gloss uniformity can be obtained. Tc(W)≤Tm(B) indicates that the crystallization temperature of the release agent is equal to or lower than the melting point of the crystalline resin. This indicates that there is a temperature zone where both the release agent and the crystalline resin are melted. In the toner of the present disclosure, the release agent and the crystalline resin interact with each other, for example by forming a eutectic, so a temperature zone where both are melted is necessary, and it is believed that Tc(W)≤Tm(B) should be satisfied. It is also believed that the presence of a temperature zone where both the release agent and the crystalline resin are melted improves color reproducibility and gloss uniformity because the crystalline resin and the release agent form a eutectic and the crystallization rate is controlled.

The above range can be satisfied by material selection of the crystalline resin and release agent and by resin design such as the molecular weight.

Tm(B)−Tc(W) is preferably 0.0° C. to 26.0° C., more preferably 5.0° C. to 25.0° C., and even more preferably 10.0° C. to 20.0° C.

Furthermore, in differential scanning calorimetry of the toner, after obtaining differential scanning calorimetry curve B, the temperature is held at 10° C. for 10 min, and then the temperature is raised from 10° C. to 180° C. at a temperature rise rate of 10° C./min to obtain a differential scanning calorimetry curve C. At this time, it is preferable that differential scanning calorimetry curve C have an endothermic peak (B2) derived from the crystalline resin. Where the peak temperature (° C.) of the endothermic peak (B2) is denoted by Tm(B2), it is preferable that Tm(B) and Tm(B2) satisfy 1.0≤Tm(B)−Tm(B2)≤10.0.

Where Tm(B)−Tm(B2) is in the above range, it indicates that Tm(B), i.e., the melting point corresponding to the toner before fixing, is higher than the melting point corresponding to the toner after fixing. As a result of Tm(B)−Tm(B2) being in the above range, the balance between low-temperature fixability and heat-resistant storage stability becomes particularly favorable. Tm(B)−Tm(B2) is more preferably 4.0° C. to 10.0° C.

Tm(B)−Tm(B2) can be increased by promoting crystallization through heat treatment near the crystallization temperature of the crystalline resin during toner production. Tm(B)−Tm(B2) can also be decreased by heating to a temperature equal to or higher than the crystallization temperature of the crystalline resin during toner production and then rapidly cooling to suppress crystallization.

Furthermore, the toner of the present disclosure has a storage elastic modulus G′(TmB) of 1.0×10⁵ Pa to 1.0×10⁸ Pa at Tm(B) [° C.]. G′(TmB) represents the storage elastic modulus of the toner near the melting point of the crystalline resin. Toners with a storage elastic modulus in this range retain a certain degree of elasticity near the melting point and are prone to the problems mentioned in the present disclosure. Where G′(TmB) is less than 1.0×10⁵ Pa, the image is easily affected by the unevenness of the paper, and gloss uniformity is likely to decrease. Where G′(TmB) is more than 1.0×10⁸ Pa, low-temperature fixability is likely to decrease.

G′(TmB) is preferably 1.0×10⁶ Pa to 6.0×10⁷ Pa, and more preferably 3.0×10⁶ Pa to 1.0×10⁷ Pa.

G′(TmB) can be increased, for example, by reducing the amount of crystalline resin added, increasing the molecular weight of the binder resin, or adding a crosslinking agent. G′(TmB) can be decreased, for example, by increasing the amount of crystalline resin added, or decreasing the molecular weight of the binder resin.

The crystalline resin will be described hereinbelow. As mentioned above, in this disclosure, a crystalline resin refers to a resin that shows a clear endothermic peak in differential scanning calorimetry (DSC) measurement.

Examples of crystalline resins include vinyl resins, polyester resins, polyurethane resins, epoxy resins, etc. that have crystallinity, but vinyl resins that have crystallinity are preferred.

The crystalline resin preferably contains 30.0% by mass or more of the monomer unit represented by the above formula (1) (also referred to hereinbelow as monomer unit (a)). Formula (1) indicates that the resin has a long-chain alkyl group, and the presence of a long-chain alkyl group in the crystalline resin makes the resin more likely to exhibit crystallinity. The crystalline resin preferably contains 30.0% by mass to 90.0% by mass, more preferably 60.0% by mass to 90.0% by mass, and even more preferably 75.0% by mass to 90.0% by mass of the monomer unit (a) represented by formula (1).

In formula (1), m represents an integer of 15 to 30. Where m is 15 to 30, the crystalline resin is more likely to exhibit crystallinity, and a toner with excellent low-temperature fixability can be obtained.

m is preferably 17 to 29, and more preferably 19 to 23.

As a method for introducing the monomer unit (a), there is a method of polymerizing the following (meth)acrylic acid esters. For example, (meth)acrylic acid esters having a linear alkyl group with 16 to 36 carbon atoms [stearyl (meth)acrylate, nonadecyl(meth)acrylate, eicosyl(meth)acrylate, heneicosanyl(meth)acrylate, behenyl(meth)acrylate, lignoceryl(meth)acrylate, ceryl(meth)acrylate, octacosyl(meth)acrylate, myristyl(meth)acrylate, dotriacontyl(meth)acrylate, etc.] and (meth)acrylic acid esters having a branched alkyl group with 18 to 36 carbon atoms [2-decyltetradecyl(meth)acrylate etc.] can be mentioned.

When the crystalline resin is a vinyl resin having crystallinity, it is possible to have other monomer units in addition to the monomer unit (a). One method for introducing the other monomer units is to polymerize the (meth)acrylic acid ester with other vinyl monomers. The other monomer units may be used alone or in combination of two or more.

Examples of other vinyl monomers include the following.

Styrene, α-methylstyrene, (meth)acrylic acid esters such as methyl (meth)acrylate, ethyl(meth)acrylate, n-butyl(meth)acrylate, t-butyl(meth)acrylate, and 2-ethylhexyl(meth)acrylate.

Monomers having a urea group: for example, monomers obtained by reacting an amine having 3 to 22 carbon atoms [primary amines (such as normal butylamine, t-butylamine, propylamine, and isopropylamine), secondary amines (such as di-normal ethylamine, di-normal propylamine, and di-normal butylamine), aniline, and cyclohexylamine] with an isocyanate having 2 to 30 carbon atoms and an ethylenically unsaturated bond by using a known method.

Monomers having a carboxy group: for example, methacrylic acid, acrylic acid, and 2-carboxyethyl(meth)acrylate.

Monomers having a hydroxy group: for example, 2-hydroxyethyl (meth)acrylate and 2-hydroxypropyl (meth)acrylate.

Monomers having an amide group: for example, acrylamide and monomers obtained by reacting an amine having 1 to 30 carbon atoms with a carboxylic acid having 2 to 30 carbon atoms and an ethylenically unsaturated bond (such as acrylic acid and methacrylic acid) by using a known method.

Monomers having a lactam structure; for example, N-vinyl-2-pyrrolidone.

Among these, it is preferable to use a monomer having a lactam structure, and it is even more preferable that the lactam structure has a five-membered ring lactam structure. It is preferable to use N-vinyl-2-pyrrolidone as a monomer having a five-membered ring lactam structure. Monomer units having a lactam structure are exemplified by monomer units represented by the above-mentioned formula (L) (preferably formula (L-1)). The crystalline resin preferably contains 1.0% by mass to 15.0% by mass, and more preferably contains from 4.0% by mass to 10.0% by mass of the monomer unit represented by formula (L) (preferably formula (L-1)).

The crystalline resin may also contain a monomer unit based on styrene. The crystalline resin preferably contains 1.0% by mass to 25.0% by mass, and more preferably contains 7.0% by mass to 15.0% by mass of the monomer unit based on styrene.

The crystalline resin may also contain a monomer unit based on (meth)acrylic acid. The crystalline resin preferably contains 0.5% by mass to 5.0% by mass, and more preferably contains 1.5% by mass to 4.0% by mass of the monomer unit based on (meth)acrylic acid.

In the case where the crystalline resin is a polyester resin, it is possible to use a resin that shows crystallinity from among polyester resins that can be obtained through a reaction between a carboxylic acid having two or more carboxy groups and a polyhydric alcohol.

Examples of the carboxylic acid having two or more carboxy groups include the following compounds.

Dibasic acids such as succinic acid, adipic acid, sebacic acid, phthalic acid, isophthalic acid, terephthalic acid, malonic acid, and dodecenyl succinic acid, anhydrides and lower alkyl esters of these, and aliphatic unsaturated dicarboxylic acids such as maleic acid, fumaric acid, itaconic acid, and citraconic acid.

Examples of the carboxylic acid having two or more carboxy groups also include 1,2,4-benzenetricarboxylic acid, 1,2,5-benzenetricarboxylic acid, and anhydrides and lower alkyl esters of these. These may be used alone or in combination of two or more.

Examples of the polyhydric alcohol include the following compounds.

Alkylene glycols (ethylene glycol, 1,2-propylene glycol, and 1,3-propylene glycol); alkylene ether glycols (polyethylene glycol and polypropylene glycol); alicyclic diols (1,4-cyclohexanedimethanol); bisphenols (bisphenol A); and alkylene oxide (ethylene oxide and propylene oxide) adducts of alicyclic diols. Alkyl moieties in alkylene glycols and alkylene ether glycols may be linear or branched.

Examples of the polyhydric alcohol further include glycerol, trimethylolethane, trimethylolpropane, and pentaerythritol. These may be used alone or in combination of two or more.

It is also possible to use a monovalent acid such as acetic acid or benzoic acid or a monohydric alcohol such as cyclohexanol or benzyl alcohol to adjust the acid value or the hydroxyl value.

Although there is no particular limitation on the method for manufacturing the polyester resin, the polyester resin can be manufactured using either a transesterification method or a direct polycondensation method or a combination of these methods.

The binder resin contains an amorphous resin in addition to the crystalline resin. Examples of amorphous resins include vinyl resins, polyester resins, polyurethane resins, and epoxy resins, but amorphous vinyl resins such as polystyrene are preferable.

Examples of vinyl monomers include the following: styrene, α-methylstyrene, and (meth)acrylic acid esters such as methyl(meth)acrylate, ethyl(meth)acrylate, n-butyl (meth)acrylate, t-butyl(meth)acrylate, and 2-ethylhexyl(meth)acrylate.

Monomers having a urea group: for example, monomers obtained by reacting an amine having from 3 to 22 carbon atoms [primary amines (such as normal butylamine, t-butylamine, propylamine, and isopropylamine), secondary amines (such as di-normal ethylamine, di-normal propylamine, and di-normal butylamine), aniline, and cyclohexylamine] with an isocyanate having from 2 to 30 carbon atoms and an ethylenically unsaturated bond by using a known method.

Monomers having a carboxy group: for example, methacrylic acid, acrylic acid, and 2-carboxyethyl(meth)acrylate.

Monomers having a hydroxy group: for example, 2-hydroxyethyl (meth)acrylate, and 2-hydroxypropyl (meth)acrylate.

Monomers having an amide group: for example, acrylamide, and monomers obtained by reacting an amine having from 1 to 30 carbon atoms with a carboxylic acid having from 2 to 30 carbon atoms and an ethylenically unsaturated bond (such as acrylic acid and methacrylic acid) by using a known method.

Among these, it is preferable to use styrene, (meth)acrylic acid, methyl (meth)acrylate, and t-butyl(meth)acrylate. The amorphous vinyl resin preferably contains a monomer unit of styrene.

The content of the amorphous resin in the binder resin is preferably 5.0% by mass to 75.0% by mass, more preferably 5.0% by mass to 50.0% by mass, even more preferably 20.0% by mass to 50.0% by mass, and still more preferably 25.0% by mass to 35.0% by mass.

The binder resin may contain a crosslinking agent as necessary. Examples of crosslinking agents that can be used include, but are not limited to, the following compounds:
Ethylene glycol dimethacrylate, ethylene glycol diacrylate, diethylene glycol dimethacrylate, diethylene glycol diacrylate, triethylene glycol dimethacrylate, triethylene glycol diacrylate, neopentyl glycol dimethacrylate, neopentyl glycol diacrylate, divinylbenzene, bis(4-acryloxypolyethoxyphenyl) propane, ethylene glycol diacrylate, 1,3-butylene glycol diacrylate, 1,4-butanediol diacrylate, 1,5-pentanediol diacrylate, 1,6-hexanediol diacrylate, neopentyl glycol diacrylate, diethylene glycol diacrylate, triethylene glycol diacrylate, tetraethylene glycol diacrylate, diacrylates of polyethylene glycol #200, #400, and #600, dipropylene glycol diacrylate, polypropylene glycol diacrylate and polyester diacrylate (MANDA, manufactured by Nippon Kayaku Co., Ltd.), as well as the above acrylates replaced with methacrylates.

The content of the crosslinking agent in the binder resin is preferably 0.01% by mass to 10.00% by mass, and more preferably 0.03% by mass to 5.00% by mass.

The toner contains a release agent. Examples of the release agent include hydrocarbon wax and ester wax. The release agent preferably contains a polyfunctional ester wax.

The hydrocarbon wax is not particularly limited, but examples thereof are as follows. Aliphatic hydrocarbon waxes: low molecular weight polyethylene, low molecular weight polypropylene, low molecular weight olefin copolymers, Fischer Tropsch waxes, and waxes obtained by subjecting these to oxidation or acid addition.

The ester wax should have at least one ester bond per molecule, and may be a natural ester wax or a synthetic ester wax.

Ester waxes are not particularly limited, but examples thereof are as follows: Esters of a monohydric alcohol and a monocarboxylic acid, such as behenyl behenate, stearyl stearate and palmityl palmitate; Esters of a dicarboxylic acid and a monoalcohol, such as dibehenyl sebacate; Esters of a dihydric alcohol and a monocarboxylic acid, such as ethylene glycol distearate and hexane diol dibehenate; Esters of a trihydric alcohol and a monocarboxylic acid, such as glycerol tribehenate; Esters of a tetrahydric alcohol and a monocarboxylic acid, such as pentaerythritol tetrastearate and pentaerythritol tetrapalmitate; Esters of a hexahydric alcohol and a monocarboxylic acid, such as dipentaerythritol hexastearate, dipentaerythritol hexapalmitate and dipentaerythritol hexabehenate; Esters of a polyfunctional alcohol and a monocarboxylic acid, such as polyglycerol behenate; and natural ester waxes such as carnauba wax and rice wax.

Among them, at least one selected from the group consisting of esters of hexahydric alcohols and monocarboxylic acids, such as dipentaerythritol hexastearate, dipentaerythritol hexapalmitate, and dipentaerythritol hexabehenate, is preferred. The release agent more preferably contains dipentaerythritol hexastearate.

The release agent used may be a hydrocarbon wax or an ester wax alone, or a combination of a hydrocarbon wax and an ester wax, or a mixture of two or more of each.

In the toner, the content of the release agent in the toner particle is preferably 1.0% by mass to 30.0% by mass, more preferably 2.0% by mass to 25.0% by mass, even more preferably 5.0% by mass to 15.0% by mass, and still more preferably 6.0% by mass to 13.0% by mass. When the content of the release agent in the toner particle is within the above range, the above-mentioned eutectic effect with the crystalline resin is easily exhibited.

The melting point of the release agent is preferably 60° C. to 120° C. When the melting point of the release agent is within the above range, the release agent melts during fixing and easily out-migrates onto the toner particle surface, making it easier to exhibit releasability. The melting point of the release agent is more preferably 70° C. to 100° C.

The toner may also contain a colorant. Examples of colorants include known organic pigments, organic dyes, inorganic pigments, and carbon black and magnetic particles as black colorants. Other colorants conventionally used in toners may also be used. Examples of yellow colorants include condensed azo compounds, isoindolinone compounds, anthraquinone compounds, azo metal complexes, methine compounds and allylamide compounds. Specifically, C.I. pigment yellow 12, 13, 14, 15, 17, 62, 74, 83, 93, 94, 95, 109, 110, 111, 128, 129, 147, 155, 168 and 180 can be used by preference.

Examples of magenta colorants include condensed azo compounds, diketopyrrolopyrrole compounds, anthraquinone compounds, quinacridone compounds, basic dye lake compounds, naphthol compounds, benzimidazolone compounds, thioindigo compounds and perylene compounds. Specifically, C.I. pigment red 2, 3, 5, 6, 7, 23, 48:2, 48:3, 48:4, 57:1, 81:1, 122, 144, 146, 166, 169, 177, 184, 185, 202, 206, 220, 221 and 254 can be used by preference. Examples of cyan colorants include copper phthalocyanine compounds and their derivatives, anthraquinone compounds, and basic dye lake compounds. Specifically, C.I. pigment blue 1, 7, 15, 15:1, 15:2, 15:3, 15:4, 60, 62 and 66 can be used by preference.

The colorants are selected based on considerations of hue angle, chroma, lightness, weather resistance, OHP transparency, and dispersibility in the toner. The content of the colorant is preferably from 1.0 to 20.0 mass parts per 100.0 mass parts of the binder resin. When a magnetic particle is used as the colorant, the content thereof is preferably from 40.0 to 150.0 mass parts per 100.0 mass parts of the binder resin.

A charge control agent may be included in the toner particle as necessary. A charge control agent may also be added externally to the toner particle. By compound a charge control agent, it is possible to stabilize the charging properties and control the triboelectric charge quantity at a level appropriate to the developing system.

A known charge control agent may be used, and a charge control agent capable of providing a rapid charging speed and stably maintaining a uniform charge quantity is especially desirable.

Organic metal compounds and chelate compounds are effective as charge control agents for giving the toner a negative charge, and examples include monoazo metal compounds, acetylacetone metal compounds, and metal compounds using aromatic oxycarboxylic acids, aromatic dicarboxylic acids, oxycarboxylic acids and dicarboxylic acids.

Examples of charge control agents for giving the toner a positive charge include nigrosin, quaternary ammonium salts, metal salts of higher fatty acids, diorganotin borates, guanidine compounds and imidazole compounds.

The content of the charge control agent is preferably from 0.01 to 20.0 mass parts, or more preferably from 0.5 to 10.0 mass parts per 100.0 mass parts of the toner particle.

The toner particle may be used as-is as a toner, but a toner may, if necessary, also be formed by mixing an external additive or the like so as to attach the external additive to the surface of the toner particle.

Examples of the external additive include inorganic fine particles selected from the group consisting of silica fine particles, alumina fine particles and titania fine particles, and composite oxides of these. Examples of composite oxides include silica-aluminum fine particles and strontium titanate fine particles.

The content of the external additive is preferably from 0.01 parts by mass to 8.0 parts by mass, and more preferably from 0.1 parts by mass to 4.0 parts by mass, relative to 100 parts by mass of the toner particle.

The toner particles may be manufactured by any conventional method such as suspension polymerization, emulsion aggregation, dissolution suspension, or pulverization within the scope of the present case. However, it is preferable to manufacture the toner particles by suspension polymerization.

The suspension polymerization method will be described hereinbelow in detail.

For example, a polymerizable monomer composition is prepared by mixing a crystalline resin synthesized in advance, polymerizable monomers for forming an amorphous resin, a release agent, and other materials such as a colorant and a charge control agent as necessary, and dissolving or dispersing the mixture uniformly.

Then, the polymerizable monomer composition is dispersed in an aqueous medium using a stirrer or the like to prepare suspended particles of the polymerizable monomer composition. The polymerizable monomers contained in the particles are then polymerized by an initiator or the like to obtain toner particles.

After polymerization, the toner particles are filtered, washed and dried by known methods, and an external additive is added as necessary to obtain the toner.

A known polymerization initiator may be used.

Examples of the polymerization initiator include: azo or diazo polymerization initiators such as 2,2′-azobis-(2,4-dimethylvaleronitrile), 2,2′-azobisisobutyronitrile, 1,1′-azobis(cyclohexane-1-carbonitrile), 2,2′-azobis-4-methoxy-2,4-dimethylvaleronitrile, and azobisisobutyronitrile; and peroxide polymerization initiators such as benzoyl peroxide, t-butyl peroxy-2-ethylhexanoate, t-butyl peroxypivalate, t-butyl peroxyisobutyrate, t-butyl peroxyneodecanoate, methylethylketone peroxide, diisopropyl peroxycarbonate, cumene hydroperoxide, 2,4-dichlorobenzoyl peroxide, and lauroyl peroxide.

Also, a known chain transfer agent and a known polymerization inhibitor may be used to adjust molecular weight.

The aqueous medium may contain an inorganic or organic dispersion stabilizer. A known dispersion stabilizer may be used.

Examples of inorganic dispersion stabilizers include: phosphates such as hydroxyapatite, tribasic calcium phosphate, dibasic calcium phosphate, magnesium phosphate, aluminum phosphate, and zinc phosphate; carbonates such as calcium carbonate and magnesium carbonate; metal hydroxides such as calcium hydroxide, magnesium hydroxide, and aluminum hydroxide; sulfates such as calcium sulfate and barium sulfate; calcium metasilicate; bentonite; silica; and alumina.

On the other hand, examples of organic dispersion stabilizers include polyvinyl alcohol, gelatin, methyl cellulose, methyl hydroxypropyl cellulose, ethyl cellulose, sodium salts of carboxymethyl cellulose, polyacrylic acid and salts thereof, and starch.

In the case where an inorganic compound is used as the dispersion stabilizer, a commercially available inorganic compound may be used as is, or the inorganic compound may be generated in an aqueous medium to obtain a finer particle.

For example, in the case of calcium phosphate such as hydroxyapatite or tribasic calcium phosphate, an aqueous solution of the phosphate and an aqueous solution of a calcium salt may be mixed under high-speed stirring conditions.

The aqueous medium may contain a surfactant. A known surfactant may be used. Examples of the surfactant include: anionic surfactants such as sodium dodecylbenzenesulfate and sodium oleate; cationic surfactants; amphoteric surfactants; and nonionic surfactants.

Methods for calculating and measuring various physical properties are described below.

### Measurement Method for Differential Scanning Calorimetry (DSC)

The endothermic peak temperature and exothermic peak temperature (Tm(B), Tm(W), Tc(B), Tc(W) and Tm(B2)) of the crystalline resin and release agent are measured in accordance with ASTM D3418-82 using a differential scanning calorimeter “Q1000” (manufactured by TA Instruments). The melting points of indium and zinc are used for temperature correction of the device detection unit, and the heat of fusion of indium is used for heat amount correction.

Toner measurements are performed by first weighing out 10 mg of toner and placing the toner in an aluminum pan, with an empty aluminum pan used as a reference. In the first temperature rise process, the temperature of the measurement sample is raised from 20° C. to 180° C. at 10° C./min while measurements are taken, and differential scanning calorimetry curve A is obtained. After that, the temperature is held at 180° C. for 10 min, then the cooling process is performed by decreasing the temperature from 180° C. to 10° C. at 10° C./min while measurements are taken, and differential scanning calorimetry curve B is obtained. Then, the temperature is held at 10° C. for 10 min and then raised again from 10° C. to 180° C. at 10° C./min in the second temperature rise process while measurements are taken, and differential scanning calorimetry curve C is obtained. The peak top temperatures of the peaks that appear in the obtained differential scanning calorimetry curves are determined and taken as the peak temperatures.

By separating the crystalline resin and release agent from the toner using the procedure described below and performing separate DSC measurement of the crystalline resin or release agent, it is possible to confirm whether the peak obtained is derived from the crystalline resin or the release agent.

### Method for Measuring Storage Elastic Modulus G′(TmB)

The storage elastic modulus G′(TmB) is measured using a viscoelasticity measurement device (rheometer) ARES (manufactured by Rheometrics Scientific).

The outline of the measurement is described in the ARES Operation Manuals 902-30004 (August 1997 edition) and 902-00153 (July 1993 edition) published by Rheometrics Scientific, and is as follows.
Measurement tool: torsion rectangular.
Measurement sample: for the toner, a rectangular sample with a width of 12 mm, height of 20 mm, and thickness of 2.5 mm is prepared using a pressure molding machine (25 kN is maintained for 30 min at room temperature). The pressure molding machine used is a 100 kN press NT-100H manufactured by NPa System Co., Ltd.

A jig and the sample are allowed to stand at room temperature (23° C.) for 1 h, and then the sample is attached to the jig. See the FIGURE. As shown in the FIGURE, the two are fixed so that the measurement part has a width of 12.0 mm, a thickness of 2.5 mm, and a height of 10.0 mm. After adjusting the temperature to the measurement start temperature of 30° C. for 10 min, the measurement is performed with the following settings.
Measurement frequency: 6.28 rad/s.
Measurement strain setting: the initial value is set to 0.1% and the measurement is performed in automatic measurement mode.
Sample elongation correction: adjusted in automatic measurement mode.
Measurement temperature: the temperature is raised from 30° C. to 150° C. at a rate of 2° C. per minute.
Measurement interval: viscoelastic data are measured every 30 sec, i.e., every 1° C.

Data are transferred through an interface to RSI Orchestrator (control, data collection and analysis software) (manufactured by Rheometrics Scientific) running on Microsoft Windows 2000.

From the measurement data, the storage elastic modulus G′ at Tm(B° C.) obtained by the DSC measurement described above is read, and G′(TmB) is calculated. Method for Separating Toner Particles from Toner

When analyzing toner particles, if the surface of the toner particles has been treated with an external additive, the external additive is separated by the following method to obtain toner particles.

A total of 160 g of sucrose (manufactured by Kishida Chemical Co., Ltd.) is added to 100 mL of ion-exchanged water and dissolved in a hot water bath to prepare a concentrated sucrose solution. A total of 31 g of the concentrated sucrose solution and 6 mL of Contaminon N (a 10% aqueous solution of a neutral detergent with pH 7 for cleaning precision measuring instruments that is composed of a nonionic surfactant, an anionic surfactant, and an organic builder, manufactured by Wako Pure Chemical Industries, Ltd.) are placed in a centrifuge tube to prepare a dispersion.

A total of 1.0 g of toner is added to this dispersion liquid, and toner lumps are broken up with a spatula or the like. The centrifuge tube is shaken with a shaker at 350 spm (strokes per minute) for 20 min. After shaking, the solution is transferred to a glass tube (50 mL) for a swing rotor and separation is performed in a centrifuge at 3500 rpm for 30 min. This operation separates the toner particles from the detached external additives.

Sufficient separation of the toner and aqueous solution is visually checked, and the toner that has separated into the top layer is separated with a spatula or the like. The collected toner is filtered with a vacuum filter and then dried in a dryer for at least 1 h to obtain toner particles. This operation is carried out multiple times to ensure the required amount.

### Method of Measuring Molecular Weight

Molecular weight such as weight-average molecular weight Mw is measured by gel permeation chromatography (GPC) in the following manner.

First, the sample is dissolved in tetrahydrofuran (THF) at room temperature over the course of 24 hours. The resulting solution is filtered through a solvent-resistant membrane filter (Maishori Disk, Tosoh Corp.) having a pore diameter of 0.2 μm to obtain a sample solution. The concentration of THF-soluble components in the sample solution is adjusted to about 0.8 mass %. Measurement is performed under the following conditions using this sample solution.
Device: HLC8120 GPC(detector: RI) (Tosoh Corp.)
Columns: Shodex KF-801, 802, 803, 804, 805, 806, 807 (total 7) (Showa Denko)
Eluent: Tetrahydrofuran (THF)
Flow rate: 1.0 mL/min
Oven temperature: 40.0° C.
Sample injection volume: 0.10 mL

A molecular weight calibration curve prepared using standard polystyrene resin (such as TSK standard polystyrene F-850, F-450, F-288, F-128, F-80, F-40, F-20, F-10, F-4, F-2, F-1, A-5000, A-2500, A-1000, A-500, Tosoh Corp.) is used for calculating the molecular weights of the samples.

Method for Separating Crystalline Resin from Toner Particles

The crystalline resin can be separated from toner by known methods, and one example thereof is shown below.

Gradient polymer LC is used as a method of separating resin components from toner. In this analysis, separation can be performed according to the polarity of the resin in the binder resin, regardless of molecular weight.

First, the toner is dissolved in chloroform. The sample is adjusted to a sample concentration of 0.1% by mass in chloroform, and the solution filtered through a 0.45 μm PTFE filter is used for measurement.

The measurement conditions for gradient polymer LC are shown below.
Apparatus: Ultimate 3000 (manufactured by Thermo Fisher Scientific Inc.)
Mobile phase: A Chloroform(HPLC), B Acetonitrile (HPLC)
Gradient: 2 min (A/B=0/100)→25 min (A/B=100/0)
   (The gradient of the mobile phase change was made linear.)
Flow rate: 1.0 mL/min
Injection: 0.1% by mass×20 μL
Column: Tosoh TSKgel ODS (4.6 mmφ×150 mm×5 μm)
Column temperature: 40° C.
Detector: Corona Charged Aerosol Detector (Corona-CAD) (manufactured by Thermo Fisher Scientific Inc.)

The resin components can be separated into two peaks according to polarity in the time—intensity graph obtained by the measurement. After that, the above measurement is performed again, and separation into two types of resin can be performed by fractionation at the time when the valleys of the respective peaks are reached.

The separated resins are subjected to DSC measurement, and the resin with a melting point peak is regarded as a crystalline resin, and that without such peak is regarded as an amorphous resin.

As for the release agent in the toner, components with a molecular weight of 3000 or less are separated as the release agent by recycle HPLC. The measurement method is shown below.

First, a chloroform solution of toner is prepared using the method described above. The resulting solution is then filtered through a solvent-resistant membrane filter “Myshori Disc” (manufactured by Tosoh Corporation) with a pore size of 0.2 μm to obtain a sample solution. The sample solution is adjusted so that the concentration of components soluble in chloroform is 1.0% by mass. This sample solution is used to perform measurements under the following conditions.
Apparatus: LC-Sakura NEXT (manufactured by Japan Analytical Industry Co., Ltd.)
Column: JAIGEL 2H, 4H (manufactured by Japan Analytical Industry Co., Ltd.)
Eluent: chloroform
Flow rate: 10.0 ml/min
Oven temperature: 40.0° C.
Sample injection volume: 1.0 ml

In calculating the molecular weight of the sample, a molecular weight calibration curve created using standard polystyrene resins (for example, product names “TSK Standard Polystyrene F-850, F-450, F-288, F-128, F-80, F-40, F-20, F-10, F-4, F-2, F-1, A-5000, A-2500, A-1000, A-500”, Tosoh Corporation) is used.

From the molecular weight curve obtained in this way, the components with a molecular weight of 3000 or less are repeatedly fractionated and the release agent is removed from the toner. The molecular weight to be fractionated may be changed in consideration of the molecular weight of the release agent.

### Method for Measuring Content Ratio of Various Monomer Units Such as Monomer Unit (a) in Resin and Number of Carbon Atoms in Alkyl Group

The content ratio of monomer unit (a) and the like in resin and the number of carbon atoms in the alkyl group are measured by 1H-NMR under the following conditions. The crystalline resin fractionated by the above method can be used as the measurement sample.
Measuring device: FT NMR device JNM-EX400 (manufactured by JEOL Ltd.)
Measurement frequency: 400 MHZ
Pulse condition: 5.0 μs
Frequency range: 10500 Hz
Number of accumulations: 64
Measurement temperature: 30° C.

Sample: 50 mg of the measurement sample is placed in a sample tube with an inner diameter of 5 mm, deuterated chloroform (CDCl₃) is added as a solvent, and this is dissolved in a thermostatic bath at 40° C. to prepare the sample.

The obtained 1H-NMR chart is analyzed to identify the structure of each monomer unit. Here, as an example, the measurement of the content ratio of monomer unit (a) in the crystalline resin and the number of carbon atoms in the alkyl group is described.

In the obtained 1H-NMR chart, from the peaks attributable to the constituent elements of monomer unit (a), a peak independent of the peaks attributable to the constituent elements of other monomer units is selected, and the integral value S1 of this peak is calculated. The integral values of the other monomer units contained in the crystalline resin are also calculated in the same manner.

When the monomer units constituting the crystalline resin are monomer unit (a) and one other monomer unit, the content ratio of monomer unit (a) is calculated in the following manner by using the integral value S1 and the integral value S2 of the peak of the other monomer unit. Here, n1 and n2 are the number of hydrogen atoms in the constituent elements to which the peak of interest for each segment belongs.

$$Content ratio of monomer unit ( a ) ( mol \% ) = \{ ( S 1 / n 1 ) / ( ( S 1 / n 1 ) + ( S 2 / n 2 ) ) \} \times 100.$$

Even if there are two or more types of other monomer units, the content ratio of monomer unit (a) can be calculated in the same way (using S3 . . . Sx, n3 . . . nx).

Also, the number of carbon atoms in the alkyl group can be calculated from the integral ratio of the proton peak in the 1H-NMR chart.

When a polymerizable monomer that does not contain hydrogen atoms in constituent elements other than the vinyl group is used, the measurement atomic nucleus is set to ¹³C using ¹³C-NMR, measurement is performed in a single pulse mode, and calculation is performed in the same way as with 1H-NMR. In addition, the measurement results of infrared absorption spectrum(IR) and gas chromatography mass spectrometry (GC-MS) may be used as necessary.

### Measurement of Content Ratio of Crystalline Resin in Toner

In the above-mentioned method for separating crystalline resin from toner particles, the content ratio of crystalline resin in the toner is calculated based on the mass of the toner before dissolving in chloroform and the mass of the crystalline resin separated from the toner particles.

Method for Separating Fatty Acid Metal Salt from Toner Particles

A total of 10.0 g of toner particles from which external additives have been separated is weighed, and the toner particles are put in a cylindrical filter paper (Toyo Roshi No. 84) and placed in a Soxhlet extractor. A total of 200 mL of tetrahydrofuran (THF) is added as a solvent, extraction is performed for 20 h, and THF-insoluble matter remaining on the cylindrical filter paper is dried and solidified. The obtained THF-insoluble matter is put in the cylindrical filter paper again and placed in the Soxhlet extractor. A total of 200 mL of chloroform is added as a solvent, and extraction is performed for 8 h. The fatty acid metal salt is separated from the toner particles by concentrating and drying the extract. The operation is repeated as necessary to obtain the required amount of fatty acid metal salt.

### Measurement of Number of Carbon Atoms in Straight-Chain Fatty Acid in Straight-Chain Fatty Acid Metal Salt

After extracting the fatty acid metal salt using the method described above, the number of carbon atoms is measured using the same method as used for measuring the number of carbon atoms in the alkyl group described above.

### Identification of Metal Valence in Straight-Chain Fatty Acid Metal Salt

After extracting the fatty acid metal salt using the method described above, the type of metal contained in the straight-chain fatty acid metal salt is analyzed using an inductively coupled plasma atomic emission spectrometry analyzer (ICP-AES (manufactured by Seiko Instruments Inc.)).

As a pretreatment, 8.00 ml of 60% nitric acid (manufactured by Kanto Chemical Co., for atomic absorption spectrometry) is added to 100.0 mg of the fatty acid metal salt to perform acid decomposition. During acid decomposition, the treatment is performed in a sealed vessel at an internal temperature of 220° C. for 1 h using a microwave high-power sample pretreatment device ETHOS1600 (manufactured by Milestone General Co., Ltd.) to prepare a polyvalent metal element-containing solution sample. After that, ultrapure water is added to make a total of 50.00 g to prepare the measurement sample. A calibration curve is created for each metal element, the type of metal contained in the fatty acid metal salt is identified, and the valence of the metal is identified from the type. In the present disclosure, the valence of the metal in the straight-chain fatty acid metal salt being two or more means a metal type in which a single metal ion can take a valence of two or more.

### EXAMPLES

The present disclosure will be specifically explained below using examples, but these are not intended to limit the present disclosure in any way. In the following formulations, parts are by weight unless otherwise specified.

### Preparation of Crystalline Resin 1

The following materials were placed in a reaction vessel equipped with a reflux condenser, a stirrer, a thermometer, and a nitrogen introduction tube under a nitrogen atmosphere.

| | |
|---|---|
| Toluene | 100.0 parts |
| Monomer composition | 100.0 parts |

(The monomer composition is a mixture of the following monomers in the proportion shown below)

| | | |
|---|---|---|
| (Docosyl acrylate (monomer (a)) | 80.0 | parts) |
| (Styrene | 10.0 | parts) |
| (N-vinyl-2-pyrrolidone | 7.0 | parts) |
| (Methacrylic acid | 3.0 | parts) |
| Polymerization initiator: t-butyl peroxypivalate | 0.5 | parts |
| (Perbutyl PV, manufactured by NOF Corp.) | | |

The inside of the reaction vessel was heated to 70° C. while stirring at 200 rpm, and polymerization reaction was carried out for 12 h, obtaining a solution in which the polymer of the monomer composition was dissolved in toluene. The temperature of the solution was then lowered to 25° C., and the solution was poured into 1000.0 parts of methanol while stirring, to precipitate the methanol insoluble matter. The resulting methanol insoluble matter was filtered off, washed with methanol, and then vacuum dried at 40° C. for 24 h to obtain crystalline resin 1.

Preparation of Crystalline Resins 2 to 7 Crystalline resins 2 to 7 were prepared in the same manner as in the preparation of crystalline resin 1, except that the types and amounts added of the monomer composition and polymerization initiator were changed as shown in Table 1.

TABLE 1

| | Monomer 1 | | Monomer 2 | | Monomer 3 | | Monomer 4 | | Polymerization | |
|---|---|---|---|---|---|---|---|---|---|---|
| | | Amount | | Amount | | Amount | | Amount | initiator | |
| | | added | | added | | added | | added | Amount added | |
| | Type | (parts) | Type | (parts) | Type | (parts) | Type | (parts) | (parts) | Mw |
| Crystalline | Docosyl | 80.0 | Styrene | 10.0 | N-vinyl-2- | 7.0 | Methacrylic | 3.0 | 0.5 | 34800 |
| resin 1 | acrylate | | | | pyrrolidone | | acid | | | |
| Crystalline | Docosyl | 80.0 | Styrene | 10.0 | N-vinyl-2- | 7.0 | Methacrylic | 3.0 | 1.0 | 28700 |
| resin 2 | acrylate | | | | pyrrolidone | | acid | | | |
| Crystalline | Docosyl | 80.0 | Styrene | 10.0 | N-vinyl-2- | 7.0 | Methacrylic | 3.0 | 0.3 | 39100 |
| resin 3 | acrylate | | | | pyrrolidone | | acid | | | |
| Crystalline | Hentriacontyl | 86.0 | Styrene | 10.0 | N-vinyl-2- | 2.0 | Methacrylic | 2.0 | 0.5 | 35400 |
| resin 4 | acrylate | | | | pyrrolidone | | acid | | | |
| Crystalline | Docosyl | 80.0 | Styrene | 17.0 | N-vinyl-2- | 0.0 | Methacrylic | 3.0 | 0.5 | 33600 |
| resin 5 | acrylate | | | | pyrrolidone | | acid | | | |
| Crystalline | Docosyl | 80.0 | Styrene | 10.0 | N-vinyl-2- | 7.0 | Methacrylic | 3.0 | 2.0 | 19400 |
| resin 6 | acrylate | | | | pyrrolidone | | acid | | | |
| Crystalline | Docosyl | 80.0 | Styrene | 10.0 | N-vinyl-2- | 7.0 | Methacrylic | 3.0 | 0.1 | 40900 |
| resin 7 | acrylate | | | | pyrrolidone | | acid | | | |

Mw indicates the weight-average molecular weight.

### Preparation of Crystalline Resin 8

A total of 281 parts of decanedioic acid and 283 parts of 1,6-hexanediol were placed in a reaction vessel equipped with a stirrer, a thermometer, a cooling tube, and a nitrogen gas introduction tube. After replacing the inside of the reaction vessel with dry nitrogen gas, 0.1 parts of Ti(OBu)₄ was added and the reaction was carried out while stirring for 8 h at about 180° C. under a nitrogen gas flow. Furthermore, 0.2 parts of Ti(OBu)₄ was added, the temperature was raised to about 220° C. and the reaction was carried out for 6 h while stirring, after which the pressure inside the reaction vessel was reduced to 1333.2 Pa and the reaction was carried out under reduced pressure to obtain crystalline resin 8 of the crystalline polyester resins. The number-average molecular weight (Mn) of crystalline resin 8 was 5500, the weight-average molecular weight (Mw) was 18000, and the melting point was 67° C.

### Example 1

### Production of Toner by Suspension Polymerization Method

### Production of Toner Particles 1

| | | |
|---|---|---|
| Styrene | 30.0 | parts |
| Colorant: copper phthalocyanine (C.I. Pigment Blue 15:3, | 6.5 | parts |

manufactured by Dainichiseika Color & Chemicals Mfg.
Co., Ltd.)

A mixture of the above materials was prepared. The mixture was placed in an attritor (Nippon Coke Corporation) and dispersed for 2 h at 200 rpm by using zirconia beads with a diameter of 5 mm to obtain a raw material dispersion liquid.

Meanwhile, 735.0 parts of ion-exchanged water and 16.0 parts of trisodium phosphate (12-hydrate) were added to a vessel equipped with a high-speed stirring device Homomixer (Primix Corporation) and a thermometer, and the temperature was raised to 60° C. while stirring at 12,000 rpm. An aqueous calcium chloride solution prepared by dissolving 9.0 parts of calcium chloride (dihydrate) in 65.0 parts of ion-exchanged water was added thereto, and the mixture was stirred at 12000 rpm for 30 min while maintaining the temperature at 60° C. Then, 10% hydrochloric acid was added thereto to adjust the pH to 6.0, yielding an aqueous medium in which an inorganic dispersion stabilizer containing hydroxyapatite was dispersed in water.

The raw material dispersion liquid was then transferred to a vessel equipped with a stirrer and thermometer, and the temperature was raised to 60° C. while stirring at 100 rpm.

| | | |
|---|---|---|
| Crystalline resin 1 | 70.0 | parts |
| Release agent | 9.0 | parts |
| (Release agent: DP18 (dipentaerythritol hexastearate), | | |
| melting point 79° C., manufactured by Nippon Seiro | | |
| Co., Ltd.) | | |
| Fatty acid metal salt (aluminum distearate) | 0.5 | parts |

The above materials were added and stirred at 100 rpm for 30 min while maintaining the temperature at 60° C., after which 9.0 parts of t-butyl peroxypivalate (Perbutyl PV, manufactured by NOF Corp.) was added as a polymerization initiator and stirring was performed for another one minute. The mixture was then poured into the aqueous medium being stirred at 12000 rpm in the high-speed stirring device. Stirring was continued for 20 min at 12000 rpm in the high-speed stirring device while maintaining the temperature at 60° C. to obtain a granulation liquid.

The granulation liquid was transferred to a reaction vessel equipped with a reflux condenser, a stirrer, a thermometer, and a nitrogen inlet tube, and the temperature was raised to 70° C. while stirring at 150 rpm under a nitrogen atmosphere. A polymerization reaction was carried out at 150 rpm for 12 h while maintaining the temperature at 70° C., and a toner particle dispersion liquid was obtained.

The obtained toner particle dispersion liquid was cooled to 45° C. while stirring at 150 rpm, and then heat-treated for 5 h while maintaining the temperature at 45° C. Thereafter, dilute hydrochloric acid was added, while maintaining the stirring, until the pH reached 1.5 to dissolve the dispersion stabilizer. The solid content was filtered off, thoroughly washed with ion-exchanged water, and then vacuum-dried at 30° C. for 24 h to obtain toner particles 1.

### Preparation of Toner 1

To 98.0 parts of toner particles 1, 2.0 parts of silica fine particles (hydrophobized with hexamethyldisilazane, number-average particle size of primary particles: 10 nm, BET specific surface area: 170 m²/g) was added as an external additive. This was mixed for 15 min at 3000 rpm using a Henschel mixer (manufactured by Nippon Coke Corporation) to obtain toner 1.

The physical properties of the obtained toner 1 are shown in Table 2. Furthermore, Table 3 shows the results of evaluation by the toner evaluation methods described below.

TABLE 2

| Toner | | | Tm(B) − | | | Tm(W) − | | Tm(B) − | Tm(B) − |
|---|---|---|---|---|---|---|---|---|---|
| particle | Tm(B) | Tc(B) | Tc(B) | Tm(W) | Tc(W) | Tc(W) | G′(TmB) | Tm(B2) | Tc(W) |
| No. | [° C.] | [° C.] | [° C.] | [° C.] | [° C.] | [° C.] | [Pa] | [° C.] | [° C.] |
| 1 | 65.0 | 44.0 | 21.0 | 75.0 | 52.0 | 23.0 | 5 × 10\hat{ }6 | 5.0 | 13.0 |
| 2 | 52.0 | 31.0 | 21.0 | 75.0 | 52.0 | 23.0 | 5 × 10\hat{ }6 | 5.0 | 0.0 |
| 3 | 78.0 | 57.0 | 21.0 | 75.0 | 52.0 | 23.0 | 5 × 10\hat{ }6 | 5.0 | 26.0 |
| 4 | 65.0 | 49.0 | 16.0 | 75.0 | 52.0 | 23.0 | 5 × 10\hat{ }6 | 5.0 | 13.0 |
| 5 | 65.0 | 41.0 | 24.0 | 75.0 | 52.0 | 23.0 | 5 × 10\hat{ }6 | 5.0 | 13.0 |
| 6 | 65.0 | 44.0 | 21.0 | 75.0 | 59.0 | 16.0 | 5 × 10\hat{ }6 | 5.0 | 6.0 |
| 7 | 65.0 | 44.0 | 21.0 | 75.0 | 50.0 | 25.0 | 5 × 10\hat{ }6 | 5.0 | 15.0 |
| 8 | 65.0 | 44.0 | 21.0 | 75.0 | 52.0 | 23.0 | 3 × 10\hat{ }5 | 5.0 | 13.0 |
| 9 | 65.0 | 44.0 | 21.0 | 75.0 | 52.0 | 23.0 | 5 × 10\hat{ }7 | 5.0 | 13.0 |
| 10 | 65.0 | 44.0 | 21.0 | 75.0 | 52.0 | 23.0 | 8 × 10\hat{ }7 | 5.0 | 13.0 |
| 11 | 65.0 | 49.0 | 16.0 | 73.0 | 50.0 | 23.0 | 5 × 10\hat{ }6 | 5.0 | 15.0 |
| 12 | 65.0 | 44.0 | 21.0 | 75.0 | 52.0 | 23.0 | 5 × 10\hat{ }6 | 0.0 | 13.0 |
| 13 | 65.0 | 44.0 | 21.0 | 75.0 | 52.0 | 23.0 | 5 × 10\hat{ }6 | 1.5 | 13.0 |
| 14 | 65.0 | 44.0 | 21.0 | 75.0 | 52.0 | 23.0 | 5 × 10\hat{ }6 | 8.5 | 13.0 |
| 15 | 65.0 | 44.0 | 21.0 | 75.0 | 52.0 | 23.0 | 5 × 10\hat{ }6 | 12.0 | 13.0 |
| 16 | 67.0 | 52.0 | 15.0 | 75.0 | 52.0 | 23.0 | 5 × 10\hat{ }6 | 5.0 | 15.0 |
| 17 | 65.0 | 49.0 | 16.0 | 75.0 | 52.0 | 23.0 | 5 × 10\hat{ }6 | 5.0 | 13.0 |
| 18 | 65.0 | 48.0 | 17.0 | 75.0 | 52.0 | 23.0 | 5 × 10\hat{ }6 | 5.0 | 13.0 |
| 19 | 65.0 | 47.0 | 18.0 | 75.0 | 52.0 | 23.0 | 5 × 10\hat{ }6 | 5.0 | 13.0 |
| 20 | 65.0 | 47.0 | 18.0 | 81.0 | 58.0 | 23.0 | 5 × 10\hat{ }6 | 5.0 | 7.0 |
| 21 | 65.0 | 47.0 | 18.0 | 75.0 | 52.0 | 23.0 | 5 × 10\hat{ }6 | 5.0 | 13.0 |
| C. 1 | 48.0 | 27.0 | 21.0 | 75.0 | 52.0 | 23.0 | 5 × 10\hat{ }6 | 5.0 | −4.0 |
| C. 2 | 82.0 | 61.0 | 21.0 | 75.0 | 52.0 | 23.0 | 5 × 10\hat{ }6 | 5.0 | 30.0 |
| C. 3 | 65.0 | 52.0 | 13.0 | 75.0 | 52.0 | 23.0 | 5 × 10\hat{ }6 | 5.0 | 13.0 |
| C. 4 | 65.0 | 38.0 | 27.0 | 75.0 | 52.0 | 23.0 | 5 × 10\hat{ }6 | 5.0 | 13.0 |
| C. 5 | 52.0 | 34.0 | 18.0 | 81.0 | 58.0 | 23.0 | 5 × 10\hat{ }6 | 5.0 | −6.0 |
| C. 6 | 65.0 | 44.0 | 21.0 | 75.0 | 62.0 | 13.0 | 5 × 10\hat{ }6 | 5.0 | 3.0 |
| C. 7 | 65.0 | 44.0 | 21.0 | 75.0 | 48.0 | 27.0 | 5 × 10\hat{ }6 | 5.0 | 17.0 |
| C. 8 | 65.0 | 44.0 | 21.0 | 75.0 | 52.0 | 23.0 | 8 × 10\hat{ }4 | 5.0 | 13.0 |
| C. 9 | 65.0 | 44.0 | 21.0 | 75.0 | 52.0 | 23.0 | 5 × 10\hat{ }8 | 5.0 | 13.0 |

In the table, for example, a description such as 5 × 10\hat{ }6 indicates 5 × 10⁶.
“C.” indicates “Comparative”.

In the table, for example, a description such as 5×10\hat{ }6 indicates 5×10⁶. “C.” indicates “Comparative”.

TABLE 3

| | Low-temperature | | | | | | |
|---|---|---|---|---|---|---|---|
| | fixability | | Heat- | Color reproducibility | | Gloss uniformity | |
| | Fixing start | | resistant | Japan Color | | Standard | |
| Toner | temperature | | storage | inclusion | | deviation of | |
| No. | [° C.] | rank | stability | rate(%) | rank | gloss | rank |
| 1 | 100 | A | A | 83 | A | 0.8 | A |
| 2 | 95 | A | C | 83 | A | 0.8 | A |
| 3 | 115 | C | A | 83 | A | 0.8 | A |
| 4 | 100 | A | A | 74 | C | 2.2 | C |
| 5 | 100 | A | A | 86 | A | 2.5 | C |
| 6 | 100 | A | A | 76 | B | 1.8 | B |
| 7 | 100 | A | A | 83 | A | 1.3 | B |
| 8 | 100 | A | A | 82 | A | 2.2 | C |
| 9 | 110 | B | A | 82 | A | 0.8 | A |
| 10 | 120 | C | A | 82 | A | 0.8 | A |
| 11 | 100 | A | A | 73 | C | 2.1 | C |
| 12 | 100 | A | C | 83 | A | 0.8 | A |
| 13 | 100 | A | B | 83 | A | 0.8 | A |
| 14 | 105 | B | A | 83 | A | 0.8 | A |
| 15 | 110 | B | A | 82 | A | 0.8 | A |
| 16 | 110 | B | A | 73 | C | 2.7 | C |
| 17 | 100 | A | A | 74 | C | 2.1 | C |
| 18 | 100 | A | A | 76 | B | 1.9 | B |
| 19 | 100 | A | A | 77 | B | 1.2 | B |
| 20 | 100 | A | A | 74 | C | 2.1 | C |
| 21 | 100 | A | A | 74 | C | 2.1 | C |
| C. 1 | 95 | A | D | 82 | A | 0.8 | A |
| C. 2 | 130 | D | A | 83 | A | 0.8 | A |
| C. 3 | 100 | A | A | 67 | D | 3.4 | D |
| C. 4 | 100 | A | A | 82 | A | 3.6 | D |
| C. 5 | 95 | A | B | 67 | D | 3.4 | D |
| C. 6 | 100 | A | A | 67 | D | 3.4 | D |
| C. 7 | 100 | A | A | 82 | A | 3.6 | D |
| C. 8 | 95 | A | A | 82 | A | 3.6 | D |
| C. 9 | 135 | D | A | 83 | A | 0.8 | A |

In the table, “C.” indicates “Comparative”.

### Toner Evaluation Methods

### <1> Low-Temperature Fixability

Process cartridges filled with toners 1 to 21 and comparative toners 1 to 9 were allowed to stand at a temperature of 25° C. and a humidity of 40% RH for 48 h. LBP-712Ci (Canon Inc.) modified to operate even when the fixing unit was removed was used to output an unfixed image with an image pattern in which nine 10 mm×10 mm square images were evenly arranged on the entire transfer paper. The toner laid-on level on the transfer paper was set to 0.80 mg/cm², and the fixing start temperature was evaluated. The transfer paper used was A4 paper (“Prover Bond Paper”: 105 g/m², manufactured by Fox River Co.).

The fixing unit of LBP-712Ci was removed to the outside, and an external fixing unit configured to operate outside the laser beam printer was used. The fixing temperature in the external fixing unit could be raised from 90° C. in 5° C. increments, and fixing was performed at a process speed of 260 mm/sec.

The fixed image was visually checked, the lowest temperature at which cold offset did not occur was defined as the fixing start temperature, and the low-temperature fixability was evaluated according to the following criteria. The evaluation results are shown in Table 3.

### Evaluation Criteria

A: Fixing start temperature is 100° C. or lower
B: Fixing start temperature is from 105° C. to 110° C.
C: Fixing start temperature is from 115° C. to 120° C.
D: Fixing start temperature exceeds 120° C.

### <2> Evaluation of Heat-resistant Storage Stability/Blocking Resistance

A total of 10 g of toner was placed in a 100 mL resin cup and allowed to stand in an environment with a temperature of 45° C. and a relative humidity of 95% for 7 days. The degree of occurrence of agglomerates was then visually confirmed, and the heat-resistant storage stability was evaluated according to the following criteria. The evaluation results are shown in Table 3.

### Evaluation Criteria

A: Agglomerates are not observed.
B: Agglomerates are visible, but they crumble easily.
C: Agglomerates are visible, but they crumble when shaken.
D: Agglomerates can be grasped and do not crumble easily.

### <3> Evaluation of Color Reproducibility

To evaluate color reproducibility, the width of the color gamut was evaluated by the Japan Color inclusion rate. LBP-712Ci was used as the image forming device, and images were formed and evaluated using cartridges provided with the device, except for the cyan cartridge. The printing environment was normal temperature and normal humidity (temperature 23° C., relative humidity 50%).

The matching certification and proofing equipment/operation certification chart used in the Japan Color certification system was used as an image for evaluating the color gamut. Printing was performed in accordance with the “ISO-compliant Japan Color for Sheet-fed Printing 2011: Japan Color 2011 for Sheet-fed Offset based on ISO12647-2 Manual.” The printing conditions are as follows.

### Printing Conditions

Printing paper: OKtop Coat 128 (Oji Paper Co., Ltd.)
Print density: Yellow 1.35, Magenta 1.53, Cyan 1.55, Black 1.70 (Measurement Conditions: after drying, status E, black backing, absolute density (including paper white)). The toner laid-on level for each color was adjusted to achieve the above print density.

### Color Gamut Evaluation Method and Criteria for Image Sample

Evaluation of the image sample for evaluation was performed using X-Rite eXact (X-Rite Co., Ltd.). Color measurement was performed in accordance with the “ISO-compliant Japan Color for Sheet-fed Printing 2011: Japan Color 2011 for Sheet-fed Offset based on ISO12647-2 Manual.” The measurement conditions are as follows.

### Measurement Conditions

Backing: white backing
UV cut filter: none
Incident/reflection method: 45/0
Observation light source: D50
Observation conditions: 2 degree viewing angle
Illumination standard: M0

Using the above-mentioned device, the chromaticity (L*, a*, b*) in the L*a*b* color system was measured for each of the red, green, and blue colors. The chroma (C*) was calculated using the following formula based on the measured color characteristics.

$${C}^{*} = {( {( {a}^{*} )}^{2} + {( {b}^{*} )}^{2} )}^{1 / 2}$$

Evaluation was performed by calculating as percentage the ratio at which the color gamut obtained for each image for color gamut evaluation included the color gamut of Japan Color.

### Evaluation Criteria for Japan Color Inclusion Rate

A: 80% or more
B: 75% or more and less than 80%
C: 70% or more and less than 75%
D: less than 70%

### <4> Evaluation of Gloss Uniformity

The fixed image with color reproducibility in the evaluation of <3> above was used. The gloss value was measured using a handy gloss meter PG-1 (manufactured by Nippon Denshoku Industries Co., Ltd.). As for the measurement conditions, both the projection angle and the reception angle were set to 75°, and all image patterns for which the laid-on level was changed were measured. The standard deviation of these measured values was used to evaluate gloss uniformity. The evaluation results are shown in Table 3.

### Gloss Uniformity Evaluation Criteria

A: Standard deviation of gloss is 1.0 or less
B: Standard deviation of gloss is more than 1.0 and 2.0 or less
C: Standard deviation of gloss is more than 2.0 and 3.0 or less
D: Standard deviation of gloss is more than 3.0

### Examples 2 to 21, Comparative Examples 1 to 9

Toner particles 2 to 21 and comparative toner particles 1 to 9 were obtained in the same manner as in Example 1, except that the materials used and the amounts added were changed as shown in Table 4. Furthermore, external addition was performed in the same manner as in Example 1 to obtain toners 2 to 21 and comparative toners 1 to 9. Table 2 shows the physical properties of the toners. Table 3 shows the results of evaluation using the toner evaluation methods described above. From the above analysis, in toners 1 and 2 to 21 and comparative toners 1 to 9, each monomer unit forming the crystalline resin was contained in the same content ratio as in the formulation described in Table 1.

TABLE 4

| Toner | Crystalline resin | | Styrene | Release agent | | Fatty acid metal salt | |
|---|---|---|---|---|---|---|---|
| particle | | Number | Number | | Number | | Number |
| No. | No. | of parts | of parts | Type | of parts | Type | of parts |
| 1 | 1 | 70.0 | 30.0 | DP18 | 9.0 | Al distearate | 0.5 |
| 2 | 2 | 70.0 | 30.0 | DP18 | 9.0 | Al distearate | 0.5 |
| 3 | 3 | 70.0 | 30.0 | DP18 | 9.0 | Al distearate | 0.5 |
| 4 | 1 | 73.0 | 27.0 | DP18 | 7.0 | Al distearate | 0.5 |
| 5 | 1 | 67.0 | 33.0 | DP18 | 11.0 | Al distearate | 0.5 |
| 6 | 1 | 70.0 | 30.0 | DP18 | 7.0 | Al distearate | 0.5 |
| 7 | 1 | 70.0 | 30.0 | DP18 | 11.0 | Al distearate | 0.5 |
| 8 | 1 | 85.0 | 15.0 | DP18 | 9.0 | Al distearate | 0.5 |
| 9 | 1 | 35.0 | 65.0 | DP18 | 9.0 | Al distearate | 0.5 |
| 10 | 1 | 25.0 | 75.0 | DP18 | 9.0 | Al distearate | 0.5 |
| 11 | 1 | 70.0 | 30.0 | HNP9 | 9.0 | Al distearate | 0.5 |
| 12 | 1 | 70.0 | 30.0 | DP18 | 9.0 | Al distearate | 0.5 |
| 13 | 1 | 70.0 | 30.0 | DP18 | 9.0 | Al distearate | 0.5 |
| 14 | 1 | 70.0 | 30.0 | DP18 | 9.0 | Al distearate | 0.5 |
| 15 | 1 | 70.0 | 30.0 | DP18 | 9.0 | Al distearate | 0.5 |
| 16 | 8 | 70.0 | 30.0 | DP18 | 9.0 | Al distearate | 0.5 |
| 17 | 4 | 70.0 | 30.0 | DP18 | 9.0 | Al distearate | 0.5 |
| 18 | 1 | 70.0 | 30.0 | DP18 | 9.0 | — | 0 |
| 19 | 1 | 70.0 | 30.0 | DP18 | 9.0 | Calcium laurate | 0.5 |
| 20 | 1 | 70.0 | 30.0 | WEP-5 | 9.0 | Al distearate | 0.5 |
| 21 | 5 | 70.0 | 30.0 | DP18 | 9.0 | Al distearate | 0.5 |
| C. 1 | 6 | 70.0 | 30.0 | DP18 | 9.0 | Al distearate | 0.5 |
| C. 2 | 7 | 70.0 | 30.0 | DP18 | 9.0 | Al distearate | 0.5 |
| C. 3 | 1 | 80.0 | 20.0 | DP18 | 5.0 | Al distearate | 0.5 |
| C. 4 | 1 | 60.0 | 40.0 | DP18 | 13.0 | Al distearate | 0.5 |
| C. 5 | 2 | 70.0 | 30.0 | WEP-5 | 9.0 | Al distearate | 0.5 |
| C. 6 | 1 | 70.0 | 30.0 | DP18 | 5.0 | Al distearate | 0.5 |
| C. 7 | 1 | 70.0 | 30.0 | DP18 | 13.0 | Al distearate | 0.5 |
| C. 8 | 1 | 95.0 | 5.0 | DP18 | 9.0 | Al distearate | 0.5 |
| C. 9 | 1 | 23.0 | 77.0 | DP18 | 9.0 | Al distearate | 0.5 |

In the table, “C.” indicates “Comparative”, and the number of parts indicate the number of parts by mass. The release agents are as follows.
HNP9 is a paraffin wax manufactured by Nippon Seiro Co., Ltd., with a melting point of 75° C.
WEP-5 is a monofunctional ester wax manufactured by NOF Corporation, Nissan Electol WEP-5, with a melting point of 85° C.

As is clear from Table 3, Examples 1 to 21 have low-temperature fixability and heat-resistant storage stability superior to those of Comparative Examples 1 to 9, and are also superior in color reproducibility and image gloss uniformity.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-175090, filed Oct. 10, 2023, which is hereby incorporated by reference herein in its entirety.

What is claimed is:

1. A toner comprising a toner particle comprising a binder resin and a release agent, wherein
the binder resin comprises a crystalline resin and an amorphous resin,
where in differential scanning calorimetry of the toner, a temperature is raised from 20° C. to 180° C. at a temperature rise rate of 10° C./min to obtain a differential scanning calorimetry curve A, then the temperature is held at 180° C. for 10 min, and subsequently the temperature is lowered from 180° C. to 10° C. at a temperature decrease rate of 10° C./min to obtain a differential scanning calorimetry curve B,
the differential scanning calorimetry curve A has an endothermic peak m(B) derived from the crystalline resin and an endothermic peak m(W) derived from the release agent,
the differential scanning calorimetry curve B has an exothermic peak c(B) derived from the crystalline resin and an exothermic peak c(W) derived from the release agent, and
where a peak temperature (° C.) of the endothermic peak m(B) is denoted by Tm(B), a peak temperature (° C.) of the endothermic peak m(W) is denoted by Tm(W), and
a peak temperature (° C.) of the exothermic peak c(B) is denoted by Tc(B), and a peak temperature (° C.) of the exothermic peak c(W) is denoted by Tc(W),
the Tm(B), the Tc(B), the Tm(W) and the Tc(W) satisfy
50.0≤Tm(B)≤80.0,
15.0≤Tm(B)−Tc(B)≤25.0,
Tc(W)≤Tm(B), and
15.0≤Tm(W)−Tc(W)≤25.0, and
a storage elastic modulus G′(TmB) of the toner at Tm(B)[C] is 1.0×10⁵ Pa to 1.0×10⁸ Pa.

2. The toner according to claim 1, wherein the release agent comprises a polyfunctional ester wax.

3. The toner according to claim 1, wherein
where in differential scanning calorimetry of the toner, after obtaining the differential scanning calorimetry curve B, the temperature is held at 10° C. for 10 min, and then the temperature is raised from 10° C. to 180° C. at a temperature rise rate of 10° C./min to obtain a differential scanning calorimetry curve C,
the differential scanning calorimetry curve C has an endothermic peak (B2) derived from the crystalline resin, and
where the peak temperature (° C.) of the endothermic peak (B2) is denoted by Tm(B2), the Tm(B) and the Tm(B2) satisfy 1.0≤Tm(B)−Tm(B2)≤10.0.

4. The toner according to claim 1, wherein a content of the crystalline resin in the binder resin is at least 25.0% by mass.

5. The toner according to claim 1, wherein the crystalline resin comprises a crystalline vinyl resin.

6. The toner according to claim 5, wherein the crystalline resin includes a monomer unit represented by formula (1) below: 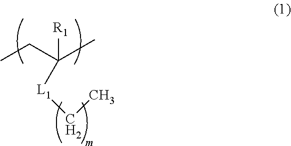
In formula (1), R₁ represents a hydrogen atom or a methyl group, L₁ represents a single bond, an ester bond, or an amide bond, and m represents an integer of 15 to 30.

7. The toner according to claim 6, wherein the toner particle comprises a straight-chain fatty acid metal salt,
where number of carbon atoms of straight-chain fatty acid in the straight-chain fatty acid metal salt is denoted by C(b),
the C(b) and m in formula (1) satisfy m−10≤C(b)≤m+10, and
the valence of the metal in the straight-chain fatty acid metal salt is 2 or more.

8. The toner according to claim 1, wherein
the release agent comprises a polyfunctional ester wax, and
the polyfunctional ester wax is at least one ester compound selected from the group consisting of an ester compound of a tetrahydric to octahydric alcohol with an aliphatic monocarboxylic acid, and an ester compound of a tetravalent to octavalent carboxylic acid with an aliphatic monohydric alcohol.

9. The toner according to claim 8, wherein
the polyfunctional ester wax is at least one ester compound selected from the group consisting of an ester compound of a hexahydric to octahydric alcohol with an aliphatic monocarboxylic acid, and an ester compound of a hexavalent to octavalent carboxylic acid with an aliphatic monohydric alcohol.

10. The toner according to claim 1, wherein the crystalline resin comprises a monomer unit having a lactam structure.

11. The toner according to claim 10, wherein the lactam structure is a 5-membered lactam structure.

12. The toner according to claim 1, wherein the amorphous resin comprises an amorphous vinyl resin.
